(19) United States
(12) Patent Application Publication
(10) Pub. No.: US 2003/0190122 A1
(43) Pub. Date: Oct. 9, 2003

(54) Method and device for signal transmission

(76) Inventor: Karel Maria Van Den Bergh, Mechelen (BE)

Correspondence Address: BACON & THOMAS, PLLC, 625 SLATERS LANE, FOURTH FLOOR, ALEXANDRIA, VA, 22314

(21) Appl. No.: 10/343,827

(22) PCT Filed: Aug. 1, 2001
(86) PCT No.: PCT/BE01/00126

(30) Foreign Application Priority Data
Aug. 10, 2000 (BE) 2000/503

(51) Int. Cl. G02B 6/38

(52) U.S. Cl. 385/55

(57) ABSTRACT

The invention relates to an optical feedthrough including an optical fiber (11) and a protective tube (10) surrounding said fiber. In the invention, a seal (6) extends inside the annular space between the protective tube and the optical fiber, the length of said seal being greater than 50 mm.

This invention relates to a method and a device for signal transmission.

In the first place, the invention is directed towards applications in the sector of domotics and immotics, in other words, applications for transmitting a variety of signals and information in a house or another building, however, more generally it may also be applied in other applications whereby a signal transmission, of which kind whatsoever, takes place.

Due to the constantly increasing flow of information, in applications of domotics and immotics as well as in other applications, higher and higher demands are made in respect to signal transmission, in the first place in respect to the amount of information which is required to be transmitted.

So, for example, with applications for domotics and immotics, up to a recent time, it had only been necessary to be able to transmit relatively small amounts of information, such as the transmission of switching signals and the like. More and more, however, there is a necessity in these applications for a possibility to transmit larger amounts of data, in order to transmit not only switching signals and the like, but also signals relating to voice and/or data and/or image formation, summarized, so-called VDI signals (Voice Data Image).

As voice, data and image are considered a must in the integrity of a building control system, or, in other words, a domotics or immotics system, such system only can be seen as complete when a VDI integration is possible. Such integration of VDI, however, requires a very large data capacity, and this for most of the applications in the form of a constant data flow with a bandwidth of 100 Mbps or more.

All systems available up to now have the serious disadvantage that they do not allow to realize applications requiring a large data capacity in an efficient manner.

The invention aims at a method and device providing a solution for one or more of said disadvantages. In the first place, thus, in general, a better form of signal transmission or data transmission is aspired. More specifically, according to a number of preferred embodiments, also solutions are intended which are particularly suited for processing large data capacities in domotics and immotics applications.

To this aim, the invention in the first place relates to a method for signal transmission, with as a characteristic that use is made of at least two signal lines, whereby the method consists in that a first of the signal lines is used as a control line, whereas a second of the signal lines is used for transmitting data, whereby the use of the second. signal line is controlled by means of the first signal line.

In that use is made of at least two signal lines, whereby the first controls the use of the second one, the advantage is created that the use of the second signal line can take place in an optimum manner. By the control, performed over the first signal line, it is actually possible to exactly control and follow up when signals can be transmitted via the second signal line, or a control can be provided for transmitting these signals via the second signal line in an optimum manner. In this manner, the second signal line can be completely reserved for a well-defined signal transmission, which then can take place in an efficient and reliable manner.

Preferably, the information is transmitted over the second signal line at a higher speed, with which a larger data transmission per time unit is intended, than the speed with which the signal is transmitted over the first signal line by which said control is performed. In consideration of the fact that the signal transmission on the second signal line is performed with a high efficiency, it actually is no problem to transmit large and possibly continuous data flows at high speeds over this second signal line.

In a practical application, for the first signal line conductors will be applied which allow a data transmission up to at least several dozens of Kbps, whereas for the second signal line, preferably conductors are used which are suited for hither data transmissions, up to more than 100 Mbps. The conductors of the first signal line then may consist of, for example, the usual cables, whereas for the second signal line, cables are used which are intended for larger data transmissions; such as UTP-, STP-, FTP-cables and the like.

In a practical embodiment, for said two signal lines use is made of parallel physical lines which, for example, can be directed along all locations where connection points may be necessary.

Preferably, the information is put onto the second signal line by means of modules, and a communication takes place between said modules, via the first signal line, in order to determine by which modules information can be transmitted over the second signal line. Thereby, information can be stored in the modules allowing that each module can make decisions in respect to the possible admission of information on the second signal line.

Thus, preferably, at least in well-defined ones of these modules, information is stored relating to the status of the availability of the second signal line, such that from these modules, it can always be determined to which extent the second signal line is available.

In a practical embodiment, one will work with at least two kinds of modules, on one hand, a first kind, the modules of which substantially are intended to provide in incoming/outgoing operations and, on the other hand, a second sort, the modules of which substantially are intended to place voice and/or data and/or image information onto the second signal line.

Hereby, not both kinds of modules have to be connected to both signal lines. Preferably, the modules of the first kind are connected exclusively to the first signal line, whereas the modules of the second kind are connected to both signal lines.

The information which is transmitted via the second signal line, or, in the case that a plurality of “seconds” signal lines is used, is transmitted over the different signal lines, can be transmitted over such signal line or signal lines in different ways.

According to a first possibility, when transmitting signals over every second signal line, the time division multiplexing principle (TDM) can be used, whereby via the first signal line a control and command is provided, such that the information to be transmitted can be transmitted undisturbed by means of well-defined time slots.

According to a second possibility, the transmission of signals over the second signal line is performed by using this signal line continuously, whereby thus a permanent connection is realized between two or more points of the system. It is also possible to use a plurality of such permanent lines, whereby then, by means of signal exchange via the first signal line or one of the “first” signal lines, it is determined and/or controlled over which of these permanent lines information to be transmitted can be sent.

According to a particular characteristic of the invention, the method is characterized in that the transmission of information over the second signal line is preceded by a control signal over the first signal line, and that, when this control signal is sent via the first signal line, provisions are made in order to prevent malfunctions occurring as a result of the simultaneous presence of several signals on the first signal line. In this manner, a completely malfunction-free system is obtained. As provisions are made for excluding malfunctions, caused in the first signal line, no difficulties will arise at that location. As the use of the second signal line is controlled by signals over the first signal line, malfunctions in the second signal line are completely excluded, as this latter is utilized in a controlled manner.

In order to exclude the aforementioned malfunctions, preferably provisions are made to avoid a collision of signals. Hereby, it is particularly practical to use an anti-collision method as described in the Belgian patent application No. 09900738.

Starting from the technique described in said Belgian patent application, the method of the present invention, according to a particularly preferred form of embodiment, then is further characterized in that, when the control signal is placed on the first signal line together with another signal in such a manner that a malfunction might arise, one of the two signals is given priority, and that only if the control signal obtains free passage, the information, which has to be sent over the second signal line, is let through.

Possibly, in combination with said technique, also a data flow can be transmitted at high speed via the first signal line, also as described in said Belgian patent application No. 09900738, which is further explained in the detailed description.

In domotics and immotics applications, as well as in other applications of similar kind, it is preferred that the first signal line is used for transmitting control signals, drive signals, signals for switching on and off and such, whereas the second signal line is used for transmitting signals related to voice, data processing and image formation.

It is noted that the term “signal line” has to be interpreted in its broadest form. Such signal line in itself may comprise several conductors and/or consist of a data bus.

The invention is not limited to the use of one first signal line and one second signal line. So, for example, according to a form of embodiment of the invention, a plurality of “second” signal lines shall be used, whereby, for example, information is exchanged via the first signal line in order to control the use of the second signal lines. It is also not excluded to apply a plurality of “first” signal lines, or a combination of a plurality of first signal lines and second signal lines also is not excluded.

One or more of the signal lines may also be realized wireless.

Of course, the invention also relates to devices, consisting of a transmission network with signal transmission and signal receiving units, in which the method described heretofore is applied.

With the intention of, better showing the characteristics of the invention, hereafter, as an example without any limitative character, several preferred forms of embodiment are described, with reference to the accompanying drawings, wherein:

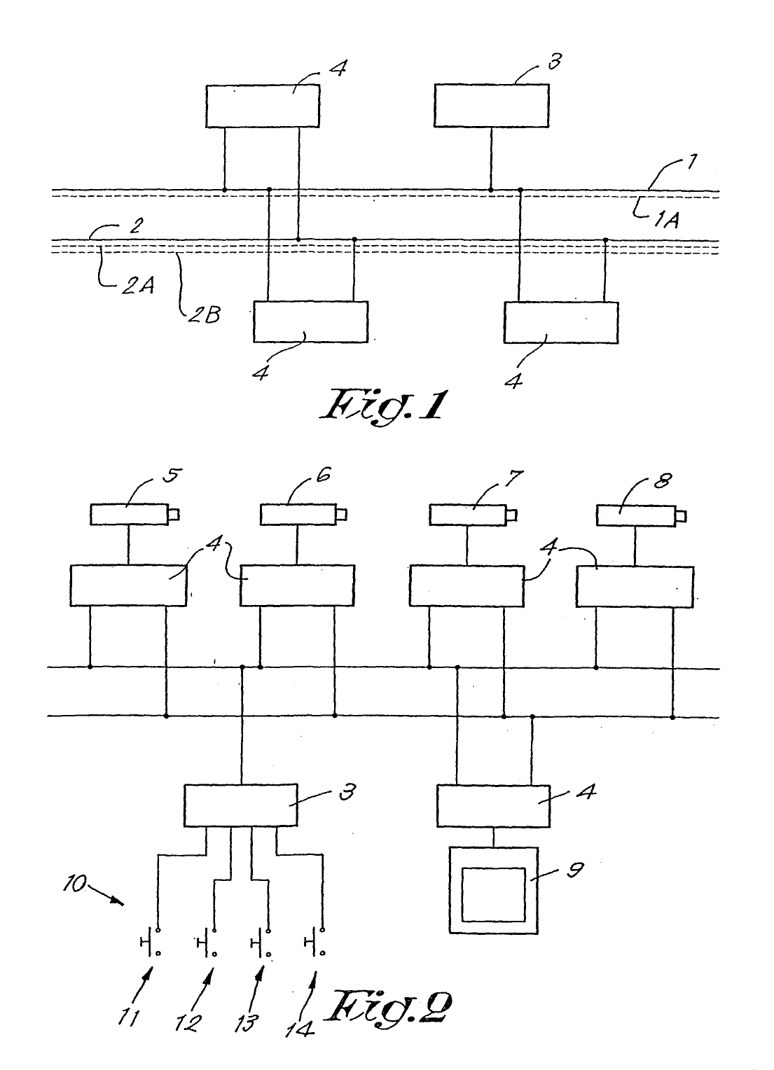

FIG. 1 schematically represents a transmission network according to the invention;

FIG. 2 schematically represents an application of the invention;

FIG. 3 schematically represents a transmission network;

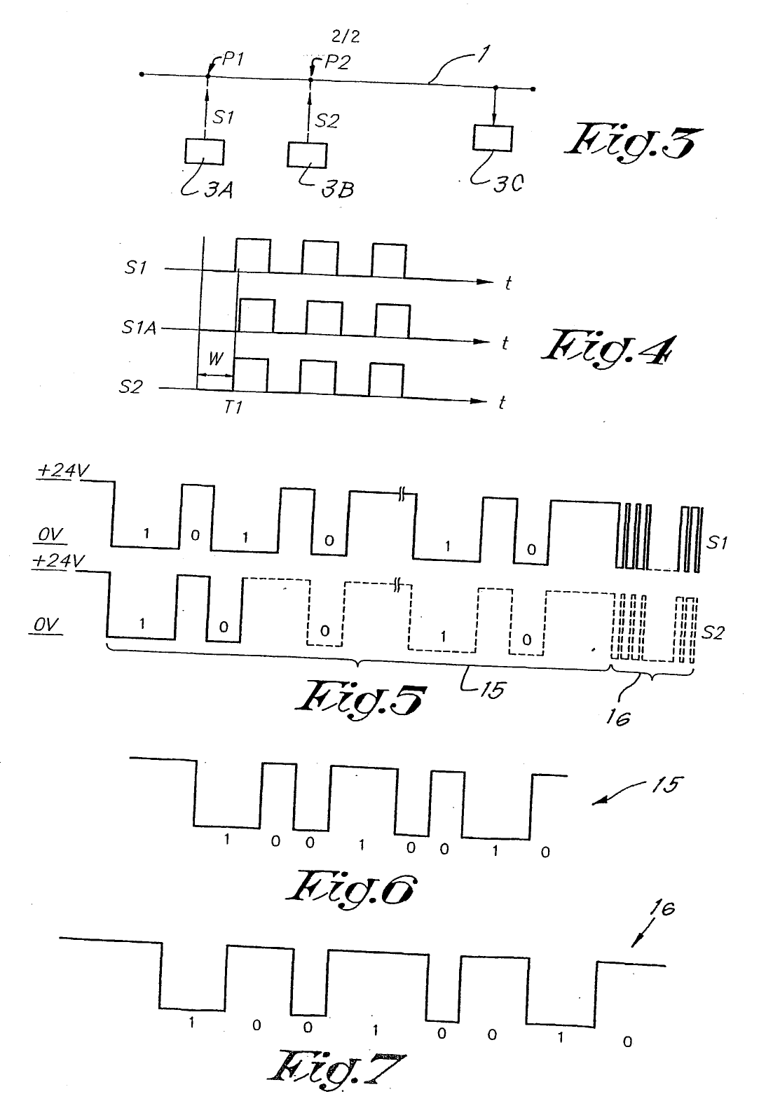

FIG. 4 schematically represents a situation which can occur during the transmission of signals;

FIG. 5 represents two signals which use the method according to the invention;

FIG. 6 represents a variant of the first signal part from FIG. 5;

FIG. 7 represents a variant of the second signal part from FIG. 5.

As represented in FIG. 1, the invention relates to a method and device for signal transmission, whereby use is made of at least two signal lines, denominated first signal line 1 and second signal line 2, respectively. The particularity hereby consists in that the first signal line 1 is used as a control line, whereas the second signal line 2 is used for transmitting data, whereby the use of the second signal line 2 is controlled via the first signal line 1.

Preferably, the signal lines 1-2 consist of parallel physical lines.

The information over the second signal line 2 preferably is transmitted at a higher speed than the information over the first signal line 1. In a practical form of embodiment, the information, as aforementioned, is transmitted over the first signal line 1 at speeds in the order of magnitude of several dozens Kbps, whereas the information over the second signal line 2 is transmitted at speeds in the order of magnitude of several Mbps, up to more than 100 Mbps.

In practice, for the first signal line 1 the usual cable material shall be used, which has to meet minor requirements, whereas for the second signal line 2 cables of the type intended for transmitting information at high speed, such as, for example, UTP, STP, FTP cables and such will be used.

In order to transmit information over the signal lines 1-2, modules 3-4 are used. Hereby, via the first signal line 1, a communication takes place between two or more modules 3-4 in order to determine via which modules 3-4 information can be transmitted over the second signal line 2.

Hereby, at least in well-defined ones of the modules 3-4 information is stored relating to the status of availability of the second signal line 2, such that from these modules 3 and/or 4, it can always be determined to what extent the second signal line 2 is available.

As represented in the example, one will work preferably with at least two kinds of modules, 3 and 4, respectively, whereby the first kind is intended for providing in incoming/outgoing operations and, on the other hand, the second kind is intended for putting voice and/or data and/or image information onto the second signal line 2. Hereby, the modules 3 of the first kind are connected exclusively to the first signal line 1, whereas the modules of the second kind are connected to both signal lines 1-2. Actually, the modules 3 only must be able to receive and give instructions and therefore do not have to be in connection with the second signal line 2. The modules 4, on the contrary, do have to be connected to signal line 1 as well as to signal line 2, as all instructions are given via the first signal line and the information or data which have to be transmitted at a high speed, substantially have to be transmitted over the signal line 2 which is appropriately provided.

For the connection between two successive modules 4, in the first place the UTP/RJ45 way of connection will be appropriate. This solution is the most inexpensive by far and the most simple to install. In such case, with the application of the standard 100 Mbit technology, the maximum length between two modules 4 is approximately 90 meters.

Preferably, each module 4 is equipped with a repeating function (repeater function), such that the overall length of the signal line 2 is almost unlimited.

Of course, it is also possible to use another conducting medium instead of UTP, STP, FTP cable or the like. So, for example, glass fiber technology may be applied. As this technology, however, is more expensive and is more difficult to install, it shall preferably exclusively be applied where major distances have to be bridged-over by parts of the second signal line 2.

As already mentioned, other techniques, however, are not excluded, and it is, for example, possible to use a wireless connection, more particularly an infrared connection.

As already mentioned in the introduction, the transmission of signals over the second signal line 2 can take place in different manners, which either can be combined with each other or not. The two most important manners used by the invention consist in, on one hand, the transmission of signals by using the time division multiplexing principle (TDM) and, on the other hand, the transmission of signals such that the signal line is used continuously as a permanent line.

It is clear that in the first case, several signals can be transmitted simultaneously over one and the same signal line 2. In the second case, an entire line is available.

Depending on the application, also a plurality of “first” signal lines and/or “second” signal lines can be provided, for example, such as indicated schematically by references 1A and 2A-2B.

The functioning of the whole, and thus also the method related thereto, can simply be deduced from the aforegoing, however, is summarized once more in the following.

In the case that on the second signal line 2, the time division multiplexing principle is used, the method is as follows. When a signal comprising a lot of information has to be transmitted over the second signal line 2, first, by means of a module 3, it is determined where and when this information can be put on the second signal line 2. Hereby, the module 3 verifies which time intervals are free on signal line 2, whereby this information, for example, is obtained by data stored in the module 3 itself, data relating to the actual status of the second signal line 2, from which is deduced which time intervals are occupied and which are free. Also, priorities may be built-in, as a result of which a module 3 itself creates free time intervals by freeing occupied time intervals from signals having no priority.

Subsequently, the signal can be put on the signal line 2.

A practical example consists, for example, in that a signal is generated by means of a doorbell and that subsequently during a well-defined time, for example, 10 minutes, a video signal originating from a first module 4 at the location of the camera is transmitted to a second module 4, for example, in the house, whereby the video signal 2 then is transmitted over the second signal line 2. Once the connection over the second signal line 2 is made, the signal line 1 then remains available for other applications.

In the case that one works with one or more permanent lines for the second signal line 2, the modules 3 determine on which signal line 2-2A-2B the information can be transmitted.

It is evident that the communication can take place between two as well as more than two points, thus, from point to point as well as from one point to several points and from several points to several points.

The allocation of channels, in other words, of the time intervals or of the different lines, can take place in different ways, four of which will be explained in the following.

The first way takes place by means of a permanent physical channel, which means that the channel is of permanent nature, which gives the user the opportunity to built up a high-speed connection by means of, for example, an immotics network. An example of such application is a simple camera observation with one monitor. In such case, there is no necessity of bringing about or interrupting such connection at regular periods of time. When the monitor is relocated, the connection well can be brought to another location in the building. Usual incoming/outgoing instructions do not have an effect on the respective channel of the second signal line 2.

A second way is to realize a temporary physical channel. This technique can be used when temporary connections have to be realized, whether or not at the same location. An example thereof is an intercom system for an apartment building. The voice channel, for which the second signal line 2 is used, is only active between the door post and the called apartment. In rest, the respective channel is not active.

A third way takes place by using the permanent virtual channel. starting and ending point are determined, but the signal on the second signal line 2, or lines 2-2A-2B, can be variable. After the rising of the voltage, first of all, free time intervals on the second signal line 2-2A-2B are searched for. By means of this technique, an optimum occupation of all time intervals on the second signal line 2 can be obtained.

A fourth way takes place by using a temporary virtual channel. As with the temporary physical channel, the connections are temporary and are built up only when a channel on the second signal line 2 is required. Here, too, the physical time intervals are not known and are only determined during use.

In FIG. 2, a specific practical application is represented diagrammatically, for operating several cameras 5-6-7-8 distributed in a building, in order to be able to call up the images from these cameras 5-6-7-8 by means of a monitor 9.

In the proximity of the monitor 9, there is an operating panel 10 with respective push-buttons 11-12-13-14 for operating the respective cameras 5 to 8. The push-buttons 11 to 14 are connected to one and the same module 3, more particularly an incoming/outgoing module, whereas the cameras 5 to 8 and the monitor 9 each are coupled to a module 4, more particularly a module which allows to place data onto the second signal line 2.

The functioning is as follows. When the image of one of the cameras, for example, camera 6, must be called up, one presses the corresponding push-button, for example, push-button 12. As a consequence, the module 3 generates a signal over the first signal line 1, by which it is determined over which channel of the signal line 2 or possibly 2A-2B the data originating from camera 6 can be transmitted. Once this is determined and a free path is created for the transmission of these data, a connection to the module 4 pertaining to monitor 9 is made by means of the module 4 pertaining to camera 6.

In the most preferred form of embodiment of the invention, the transmission of information over the second signal line 2 thus is preceded by a control signal over the first signal line 1. Preferably, when transmitting this control signal, moreover provisions are made in order to prevent malfunctions occurring as a result of the simultaneous presence of several signals on the first signal line 1. More particularly, to this aim a method will be applied for preventing the collision of signals, such as described in the Belgian patent application No. 09900738. This method again will be integrally explained in the following, with reference to FIGS. 3 to 7.

In FIG. 3, a signal line 1 comprising units, more particularly modules 3A-3B-3C, by means of which signals can be transmitted, received, respectively, is represented schematically. In the represented example, the modules 3A and 3B-are sending signals S1 and S2, whereas the module 3C, for example, forms a unit which has to be controlled by means of said signals S1-S2.

As illustrated in FIG. 4, it is, in the first place, intended to work with pulse-shaped signals S1 and S2.

It is evident that it is desirable that the signals S1 and S2 do not exert a mutual influence. In order to exclude such mutual influence, one may determine whether there is already a signal present on signal line 1 and, in such case, may wait with the transmission of another signal. Hereby, a waiting time can be taken into account in order to exclude that, in the case that measurements have been taken just in between two pulses, this should be interpreted as if no signal was present.

Said waiting time shall have to have at least the duration of the longest bit of a signal in order to offer the certainty that the signal line 1 is free at the location where the respective signal is put onto this line.

This waiting time, however, does not allow to exclude any possibility of an interference of signals, as will be explained in the following with reference to FIG. 4.

FIG. 4 shows three curves, of the signal S1 at the location P1 in FIG. 3, of the signal SI at the location P2 in FIG. 3, whereby this signal then is named S1A, as well as of the signal S2 at the location P2, respectively.

The second and third curves of FIG. 4 show that, notwithstanding the fact that a waiting time W has been taken into account, during which no signal has been observed at the location P2, still already a signal, to wit the signal S1, is present on the signal line 1. At the moment t1, the signal S1 namely has not reached the location P2, but actually has left the location P1. When, at that moment, the signal S2 is put onto the signal line 1, both signals S1 and S2 are present on this line at the same time, which may lead to the aforementioned disadvantages.

According to the invention, at least according to a preferred form of embodiment, this is prevented in the manner as explained hereafter with reference to FIG. 5.

In FIG. 5, two signal parts 15 and 16 are used, whereby according to the present invention the second signal part 16 is optional, in other words, shall not always be used. To this signal part 16, recurrence will be made in the further description.

FIG. 5 shows that both signals S1 and S2 are simultaneously present on the signal line 1. According to the invention, at both units, modules 3A and 3B, respectively, the course of the first signal parts 15 is followed up. From the moment that the signal observed at the module 3A on the signal line 1 no longer corresponds to the signal sent by module 3A, the signal S1 immediately is interrupted. The same is valid for the module 3B in the case that, at this module 3B, a signal should be observed on the signal line 1 which no longer corresponds to the signal S2 sent by the module 3B itself. Thereby, it is achieved that the signals S1 and S2 only can be on the signal line 1 at the same time if they are identical. If not, only one signal S1 or S2 will remain, because, as aforementioned, then one of the signals S1 or S2 will be given priority.

In this manner, it is assured that, if the phenomenon of FIG. 4 occurs, automatically the interference of two different signals on the first signal line 1 is avoided.

By means of said technique, it is obtained that it is always known with certainty whether or not an entry to the transmission network is obtained, before the actual information is transmitted via the second signal line 2. If this entry is not obtained, then it will be simply waited and a following trial be made until passage is obtained.

As aforementioned and as represented in FIG. 5, the signals S1 and S2 may comprise a second signal part 16, with which possibly also useful information can be transmitted. In that, by means of the first signal part 15, it is verified whether the path is free for transmitting signals over the first signal line 1, then, when the first signal part 15 indeed obtains passage, immediately such signal part 16 with useful information can be coupled thereto, as one then has the certainty that this information can not be disturbed any more. The second signal part 16 then can also be transmitted at a higher transmission speed, by which is meant with a larger number of bits per second.

By using such second signal part 16, and by transmitting this second signal part 16 moreover faster than the first signal part 15, the capacity of the transmission network can be additionally increased. According to this form of embodiment, the transmission of a large amount of data at high speed can be performed in the form of a second signal part 16 over the second signal line 1 as well as a signal over the second signal line 2.

Regarding the transmission speed of the first signal part 15, also in the case when no second signal part 16 is used, it is noted that this speed is chosen such, in function of the pulses applied, that the smallest period which can be covered by such pulse is larger than the period of time necessary for an electronic signal to pass the longest possible way over which the signals S1-S2 are transmitted at a time.

In the represented example of FIG. 3, this is the distance between the most extreme points of the signal line 1.

More particularly, it is preferred that said period of time covered by such pulse-shaped signal is chosen such that it is at least twice the aforementioned period of time. In practice, however, a considerably larger period of time will be chosen for the pulses, preferably of the order of magnitude of 50 μs.

The determination of the aforementioned priority preferably is performed by mutually comparing the signals S1 and S2 bit by bit, at the module 3A as well as at the module 3B, whereby, as soon as a detectable difference is observed, the signal transmitted at the module 3A of 3B detecting such difference is interrupted immediately.

As represented in FIG. 5, said selection, or, in other words, choice of priority, can be realized in a simple manner by using, for the first signal part 15, signals S1-S2 which are obtained by creating a voltage and drawing this voltage downward by pulses. In FIG. 5, this is indicated by the voltage of “+24V”, whereby a pulse is created by drawing the voltage level to “0V”. It is, however, clear that hereby any voltage level can be applied.

Long, downward-directed pulses hereby represent a “1”, whereas short pulses represent a “0”.

Said drawing downward can be realized by means of a connection between the line on which the voltage of “+24V” is situated and a line situated on a lower level, in this case, of “0V”. Of course, this connection is realized in the modules 3A and 3B in function of the signals S1 and S2 to be transmitted.

In the practical embodiment, this connection will be realized by means of a single central common line closure which functions as a current source. Such line closure offers the advantage that very straight flanks are obtained for the pulses.

From FIG. 5, it is clear that, when the signals S1 and S2 are compared bit by bit, the first alteration between the sent signal S2 and the signal situated on the signal line 1 is observed in the module 3A. The control of the module 3B actually keeps this signal at the lowest level and at that moment determines the signal on the signal line 1. This has as a consequence that, by means of an appropriate control in module 3B, the signal S2 is interrupted immediately and the further course, indicated in dashed line, is no longer pursued.

As becomes clear from FIG. 5, for the signal transmission of the first signal part 15 and, preferably, also of the second signal part 16, pulse width modulation is used.

In order to enhance the signal transmission without a loss of quality, one may work with a double modulation, as illustrated in FIGS. 6 and 7, for the signal parts 15 and 16, respectively. Hereby, a modulation is performed at the lower as well as at the upper level of the signals S1 and S2, more particularly the lower and the upper levels of the pulses of which these signals S1 and S2 are consisting.

The invention is in no way limited to the forms of embodiment described in the aforegoing and represented in the figures, on the contrary may such method for signal transmission, and the device used thereby, be realized in different variants without leaving the scope of the invention.

1.- Method for signal transmission, characterized in that at least two signal lines (1-1A-2-2A-2B) are used, whereby the method consists in that a first of the signal lines (1-1A) is used as a control line, whereas a second of the signal lines (2-2A-2B) is used for data transmission, whereby the use of the second signal line (2-2A-2B) is controlled via the first signal line (1-1A).

2.- Method according to claim 1, characterized in that the information is transmitted over the second signal line (2-2A-2B) at a higher speed than the information over the first signal line (1-1A).

3.- Method according to claim 1 or 2, characterized in that the information is transmitted over the first signal line (1-1A) at a speed of several Kbps up to several dozens of Kbps, whereas the information is transmitted over the second signal line (2-2A-2B) at a speed of several dozens of Mbps up to more than hundred Mbps.

4.- Method according to any of the preceding claims, characterized in that at least for the second signal line (2-2A-2B) cables of the type are used intended for transmitting information at high speed, such as UTP, STP, FTP cables and the like.

5.- Method according to any of the preceding claims, characterized in that for said two signal lines (1-1A-2-2A-2B), parallel physical lines are used.

6.- Method according to any of the preceding claims, characterized in that the information is put onto the second signal line (2-2A-2B) by means of modules (3-3A-3B-3C-4) and that, by means of the first signal line (1-1A) communication takes place between said modules (3-3A-3B-3C-4) in order to determine via which modules (3-3A-3B-3C-4) information can be transmitted over the second signal line (2-2A-2B).

7.- Method according to any of the preceding claims, chracterized in that at least in well-defined ones of the modules (3-3A-3B-3C-4) information is stored relating to the status of availability of the second signal line (2-2A-2B), such that from these modules (3-3A-3B-3C-4), it can always be determined to what extent the second signal line (2-2A-2B) is available.

8.- Method according to claim 7, characterized in that at least two kinds of modules (3-3A-3B-3C-4) are used, on one hand, a first kind, the modules (3-3A-3B-3C) of which substantially are intended for providing in incoming/outgoing operations and, on the other hand, a second kind, the modules (4) of which substantially are intended for placing voice and/or data and/or image information onto the second signal line (2-2A-2B).

9.- Method according to claim 8, characterized in that the modules (3-3A-3B-3C) of the first kind are connected exclusively to the first signal line (1-1A), whereas the modules (4) of the second kind are connected to both signal lines (1-1A-2-2A-2B).

10.- Method according to any of the preceding claims, characterized in that at least one second signal line (2-2A-2B) is used, whereby, when signals are transmitted over this second signal line (2-2A-2B), the time division multiplexing principle (TDM) is used.

11.- Method according to any of the preceding claims, characterized in that at least one second signal line (2-2A-2B) is used, whereby, when signals are transmitted over this second signal line (2-2A-2B), this signal line (2-2A-2B) is used in a continuous manner as a permanent line.

12.- Method according to claim 11, characterized in that a plurality of such signal lines (2-2A-2B) are used, whereby the use of these signal lines (2-2A-2B) is controlled by means of the first signal line (1-1A).

13.- Method according to any of the preceding claims, characterized in that the transmission of information over the second signal line (2-2A-2B) is preceded by a control signal over the first signal line (1-1A) and that, upon transmitting this control signal over the first signal line (1-1A), provisions are made in order to avoid malfunctions as a consequence of the simultaneous presence of several signals on the first signal line (1-1A).

14.- Method according to claim 13, characterized in that, when the control signal is placed together with another signal onto the first signal line (1-1A) in such a manner that a malfunction might occur, one of the two signals is given priority, and that only when the control signal receives free passage, the information, which has to be transmitted over the second signal line (2-2A-2B), is let through.

15.- Method according to.claim 13 or 14, characterized in that, if two or more signals (S1-S2) are transmitted simultaneously via the first signal line (1-1A), the signals (S1-S2) are mutually compared bit by bit and that the signal showing a detectable difference in comparison to another, simultaneously transmitted signal, is immediately interrupted.

16.- Method according to any of the preceding claims, characterized in that for the signal transmission over the first signal line (1-1A), pulse width modulation is used.

17.- Method according to any of the preceding claims, characterized in that, preceding the transmission of a signal (S1) over the first signal line (1-1A), it is verified whether, during a well-defined period of time, any other signal (S2) is present at the location where the first-mentioned signal (S1) is transmitted, and the first-mentioned signal (S1) is only let through when during said period of time no other signal (S2) has been observed at said location, which period of time at least corresponds to the transmission time of the longest possible bit.

18.- Method according to any of the preceding claims, characterized in that for the signal transmission over the first signal line (1-1A), at least one signal part (15) is provided, for which signal part pulse-shaped signals are used, and that to this end, pulses are applied whereby the shortest period of time which can be covered by such pulse is longer than the period of time required by an electronic signal to pass the longest possible path over which the signals are transmitted at a time.

19.- Method according to any of the claims 13 to 18, characterized in that for the transmission of at least a quantity of the information, two signal parts (15-16) on the first signal line (1-1A) are used, whereby, by means of the first signal part (15), it is verified whether the path is free for transmitting information, and if so, the second signal part (16) subsequently is transmitted over the first signal line (1-1A).

20.- Method according to claim 19, characterized in tht the second signal part (16) is transmitted at a higher transmission speed than the first signal part (15).

21.- Method according to any of the preceding claims, characterized in that several lines are used as “firstly” signal lines (1-1A) and/or as “second” signal lines (2-2A-2B).

22.- Device, consisting of a transmission network with signal-transmitting and signal-receiving units, characterized in that it applies the method according to any of the preceding claims.

23.- Device according to claim 22, characterized in that it forms part of a domotics or immotics application.
